(19) United States
(12) Patent Application Publication
(10) Pub. No.: US 2011/0007786 A1
(43) Pub. Date: Jan. 13, 2011

(54) MODEM WITH DATA CABLE

(75) Inventor: CHIEN-CHANG LIU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/556,243

(22) Filed: Sep. 9, 2009

(30) Foreign Application Priority Data
Jul. 10, 2009 (TW) 98123377

(51) Int. Cl. H04B 1/38

(52) U.S. Cl. 375/222

(57) ABSTRACT

A modem connected to a communication terminal to process communication signals, includes a central processing unit (CPU) for modulating/demodulating signals, a primary antenna connected to the CPU for receiving/sending signals, an interface connected to the CPU and a data cable connecting the communication terminal to the interface. The impedances of the data cable and the primary antenna match each other, such that the data cable resonates with the primary antenna and functions as a secondary antenna when the primary antenna works.

### BACKGROUND

1. Technical Field

The present disclosure relates to modems, and particularly to a modem having an improved communication quality.

2. Description of Related Art

Modems are widely used in networks. Similarly to many electronic devices, modems are miniaturized for portability and easier installation. However, a modem usually has an antenna mounted thereon for receiving/sending wireless communication signals. When the modem with the antenna is miniaturized, many communication parameters of the reduced antenna (e.g., frequency band, plus and efficiency, etc.) may also be changed, and the communication quality of the antenna (especially in low frequency bands) may be deteriorated.

Therefore, there is room for improvement within the art.

### BRIEF DESCRIPTION OF THE DRAWINGS

Many aspects of the present modem can be better understood with reference to the following drawings. The components in the various drawings are not necessarily drawn to scale, the emphasis instead being placed upon clearly illustrating the principles of the present modem. Moreover, in the drawings, like reference numerals designate corresponding parts throughout the figures.

FIG. 1 is a block diagram of a modem connected to a communication terminal, according to an exemplary embodiment.

FIG. 2 is a graph of the return loss of the modem shown in FIG. 1, compared with the return loss of a conventional modem.

### DETAILED DESCRIPTION

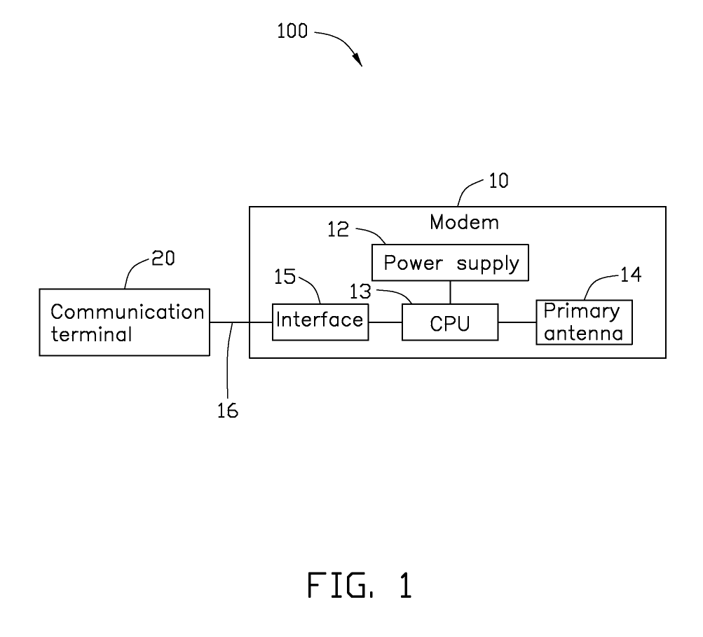

Referring to FIG. 1, a modem 100 according to an exemplary embodiment is shown. The modem 100 is connected to a communication terminal 20, e.g., a personal computer (PC), to modulate/demodulate communication signals. The modem 100 includes a power supply 12, a central processing unit (CPU) 13, a primary antenna 14, an interface 15 and a data cable 16. The power supply 12, the primary antenna 14 and the interface 15 are all electronically connected to the CPU 13. The data cable 16 connects the communication terminal 20 to the interface 15 and transmits data between the communication terminal 20 and the modem 100.

The power supply 12 is a conventional power supply, such as a battery, which is used to supply working electric energy to the modem 100. The CPU 13 is a single chip or a microprocessor, which is used to modulate communication signals generated by the communication terminal 20 and demodulate wireless communication signals received by the primary antenna 14. The primary antenna 14 can be a rod antenna or a planar antenna, which is used to receive wireless communication signals from networks and send wireless communication signals to networks.

The data cable 16 is a coaxial-cable or a twisted-pair. Aside from the conventional use (i.e., transmitting data, as above-mentioned), the data cable 16 can also be used as a secondary antenna of the modem 100. When the length of the data cable 16 is about a half of a wavelength of principal communication signals received/sent by the primary antenna 14, the impedances of the data cable 16 and the primary antenna 14 will match each other. Thus, the data cable 16 can resonate with the primary antenna 14 when the primary antenna 14 works.

In use, communication signals generated by the communication terminal 20 are transmitted to the CPU 13 via the data cable 16 and the interface 15. The CPU 13 modulates the communication signals, and the modulated communication signals are then transmitted to the primary antenna 14 to be wirelessly sent to networks. The primary antenna 14 also receives wireless communication signals from networks and transmits the wireless communication signals to the CPU 13. The CPU 13 demodulates the signals and transmits the demodulated signals to the communication terminal 20 via the interface 15 and the data cable 16. In this working process, since the impedances of the data cable 16 and the primary antenna 14 match with each other, the data cable 16 resonates with the primary antenna 14 and works as a secondary antenna of the modem 100 to receive/send signals, and the power of the signals transferred via the data cable 16 can be maximized.

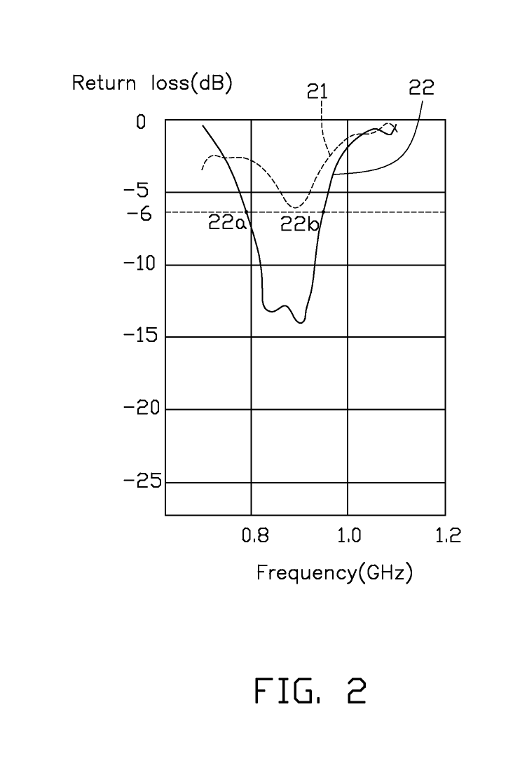

Referring to FIG. 2, a conventional modem and the present modem 100 are both used to receive/send signals in a widely used low communication frequency band of about 600 Hz-1200 MHz. The conventional modem has only a conventional antenna (e.g., similar to the primary antenna 14) used to receive/send signals. The modem 100 has the primary antenna 14 and the data cable 16 used to receive/send signals as the aforementioned method.

The two curves 21, 22 respectively express the return losses of the conventional modem and the present modem 100 used in the frequency band. Generally, if a return loss of a modem in the frequency band is not more than −6 dB, the communication quality of the modem is acceptable. As shown in FIG. 2, the return loss of the conventional modem is more than −6 dB. Unlike with the conventional modem, the return loss of the modem 100 is less than −6 dB when the modem 100 works between the two frequencies respectively labeled by the points 22a, 22b, which respectively corresponds to working frequencies of about 786 MHz and 950 MHz. This frequency band includes many low frequency bands widely used in wireless communication networks, e.g., GSM850 and EGSM900, etc. Therefore, the modem 100 with the data cable 16 used as a secondary antenna has a high communication quality of receiving/sending communication signals in low frequencies (i.e., having high wavelengths).

Understandably, despite the size of the primary antenna 14 is reduced to adapt to the miniaturization of the modem 100, the data cable 16 can also be used as a secondary antenna. According to different working conditions, the ratio of the length of the data cable 16 to the wavelength of the primary antenna 14 can also be regulated. Thus, the data cable 16 effectively increases the working efficiency of the primary antenna 14 and prevents the communication quality of the miniaturized modem 100 from being deteriorated.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A modem connected to a communication terminal to process communication signals, comprising:
a central processing unit (CPU) for modulating/demodulating signals;
a primary antenna connected to the CPU for receiving/sending signals;
an interface connected to the CPU; and
a data cable connecting the communication terminal to the interface, wherein the impedances of the data cable and the primary antenna match each other, such that the data cable resonates with the primary antenna and functions as a secondary antenna when the primary antenna works.

2. The modem as claimed in claim 1, wherein a length of the data cable is half of a wavelength of communication signals received/sent by the primary antenna.

3. The modem as claimed in claim 1, wherein the primary antenna and the data cable receive/send signals in a frequency band of about 786 MHz-950 MHz.

4. The modem as claimed in claim 1, wherein the data cable is a coaxial-cable.

5. The modem as claimed in claim 1, wherein the data cable is a twisted-pair.

6. The modem as claimed in claim 1, further comprising a power supply connected to the CPU.

7. A modem for processing communication signals, comprising:
a primary antenna for receiving/sending signals; and
a data cable connecting the modem to a communication terminal, wherein the impedances of the data cable and the primary antenna match each other, such that the data cable resonates with the primary antenna and functions as a secondary antenna when the primary antenna works.

8. The modem as claimed in claim 7, wherein a length of the data cable is half of a wavelength of communication signals received/sent by the primary antenna.

9. The modem as claimed in claim 7 wherein the primary antenna and the data cable receive/send signals in a frequency band of about 786 MHz-950 MHz.

10. The modem as claimed in claim 7, wherein the data cable is a coaxial-cable.

11. The modem as claimed in claim 7, wherein the data cable is a twisted-pair.
